(19) United States
(12) Patent Application Publication
(10) Pub. No.: US 2008/0062522 A1
(43) Pub. Date: Mar. 13, 2008

(54) Apparatus and process for aqueous cleaning of diffraction gratings with minimization of cleaning chemicals

(75) Inventors: Jerald A. Britten, Clayton, CA (US); Curly Ray Hoaglan, Livermore, CA (US); James D. Nissen, Livermore, CA (US); Thomas C. Carlson, Livermore, CA (US); David Van Lue, Livermore, CA (US); Michael D. Aasen, Livermore, CA (US)

Correspondence Address: James S. Tak;Attorney for Applicants, Lawrence Livermore National Laboratory, P.O. Box 808, L-703, Livermore, CA, 94551, US

(73) Assignee: The Regents of the University of California

(21) Appl. No.: 11/900,325

(22) Filed: Sep. 10, 2007

Related U.S. Application Data
(60) Provisional application No. 60/843,462, filed on Sep. 8, 2006.

(51) Int. Cl. G02B 27/44

(52) U.S. Cl. 359/566

(57) ABSTRACT

An apparatus and method of cleaning a diffraction grating with minimal use of cleaning chemicals. The apparatus includes a processing vessel having a sump at a lower end thereof, and an inclined platform for receiving a diffraction grating within the processing vessel so that a top surface of the diffraction grating is in an inclined position. This enables fluid runoff from the top surface of the diffraction grating to drain into the sump where it is recirculated via a recirculation line which channels (using a pump) fluid from the sump to a recirculation spout positioned to direct fluid onto the top surface of the diffraction grating. Additionally, by measuring the amount of waste cleaning fluid (acid) collected, a neutralizing agent may be dispensed to neutralize any remaining cleaning fluid in the system so that waste fluid may be released without limitation.

### II. REFERENCE TO PRIOR APPLICATIONS

This application claims priority in provisional application filed on Sep. 8, 2006, entitled “Apparatus and Process for Aqueous Cleaning of Diffraction Gratings with Minimization of Cleaning Chemicals” Ser. No. 60/843,462, by Jerald A. Britten et al, and incorporated by reference herein.

### I. FEDERALLY SPONSORED RESEARCH OR DEVELOPMENT

The United States Government has rights in this invention pursuant to Contract No. W-7405-ENG-48 between the U.S. Department of Energy and the University of California for the operation of Lawrence Livermore National Laboratory.

### III. BACKGROUND OF THE INVENTION

A. Technical Field

The present invention relates to cleaning diffraction gratings, and more particularly to an apparatus and method of cleaning diffraction gratings by exposure to a number of cleaning and rinsing steps using minimal cleaning chemicals.

B. Description of the Related Art

Diffraction gratings are an essential component of high-energy short-pulse laser systems (e.g. Petawatt lasers). They act to expand the time-duration of seed pulses to enable propagation of these pulses through gain media for purposes of amplification, and then to re-compress the time duration of these pulses following amplification. As discussed in the article entitled, “Manufacture and Development of Multilayer Diffraction Gratings,” Proc. of SPIE Vol. 5991, September 2005, incorporated by reference herein, multilayer dielectric (MLD) diffraction gratings are often preferred for such applications due to the high intrinsic laser damage thresholds of the materials comprising the MLD grating.

In order for such gratings to operate properly and optimally, however, it is important that the grating surface be completely clean and free from any contamination that can possibly absorb any small fraction of the incident light, as this absorption leads to multi-photon ionization, electronic avalanche breakdown and physical damage to the grating surface due to high laser intensities and the electric field enhancement effects of the grating surface inherent during the recompression process. The process of manufacturing gratings, however, can introduce a wide variety of surface contaminants, including, for example, organic photoresist material from the mask generation process, metals and fluoro-hydrocarbon deposits from the ion-beam etching process, and airborne organic and particulate contamination from all types of sources. It is the deposits from the ion beam etching steps that are typically the most troublesome to remove.

One known method for cleaning diffraction gratings involves exposing the grating to an oxygen plasma in a vacuum process. While this is effective in oxidizing and desorbing organic contamination, it does little to remove trace metallic contamination, for instance. Other cleaning methods are also known for cleaning mirrors, lenses, and other substantially planar optics subjected to high laser intensities, which employ mechanical means, such as ultrasonic, megasonic, or manual contact of the surface, even by polishing compounds, to mechanically remove contaminants. However, the submicron surface relief structures of diffraction gratings are extremely fragile and cannot survive such mechanical cleaning methods.

Aqueous cleaning chemistries are effective in removing these types of residues. The semiconductor industry uses these chemistries to clean silicon wafers after various processing steps. These tools consist of quick-dump rinsers that immerse containers containing several wafers into a chemical bath, or alternatively spin-cleaners that introduce cleaning chemicals on the surface of a wafer spinning at a high rate of speed. The MLD gratings of this disclosure, are very large (up to 1 m×0.5 m×0.05 m, weighing >100 KG). Thus, they are impractical to clean by immersion due to the very large quantities of chemical needed for an immersion bath with subsequent waste disposal problems, and especially since only one face of the optic needs treatment. For example, a dip-tank system to treat the largest optics would require a minimum of 8 gallons of acid and possibly more, rather than less, if a smaller optic were to be processed due to a lesser displacement volume. They are also not amenable to a spin-rinse process due to the dangers inherent in spinning this large mass at high speeds. And spray systems are problematic for safety reasons.

Therefore, it would be advantageous to provide a method for cleaning diffraction gratings involving a number of cleaning operations to remove all contamination from the surface of an MLD diffraction grating that are not all removable by a single cleaning process or chemistry. An apparatus is required that effectively irrigates the surface of the grating with a small amount of cleaning chemical, while providing sufficient flow or agitation to assist in removal of contaminants. Such equipment should be engineered with the goals of maximum operator safety, thermal control of the chemistry, in-situ neutralization of caustic and corrosive chemicals, and minimization of hazardous chemical waste.

### IV. SUMMARY OF THE INVENTION

One aspect of the present invention includes an apparatus for cleaning diffraction gratings comprising: a processing vessel having a sump at a lower end thereof, and means for receiving a diffraction grating within the processing vessel so that a top surface of the diffraction grating is in an inclined position, whereby fluid runoff from the top surface of the diffraction grating drains into the sump; a recirculation line for channeling fluid from the sump to a recirculation spout positioned to direct fluid onto the top surface of the diffraction grating; a pump for pumping fluid from the sump through the recirculation line and onto the top surface of the diffraction grating, whereby runoff from the top surface of the diffraction grating is recirculated back thereto; means for introducing a cleaning fluid into the processing vessel; means for introducing a rinsing fluid into the processing vessel; and means for draining fluid out from the sump and the recirculation line.

Another aspect of the present invention includes an apparatus for cleaning a diffraction grating comprising: a processing vessel having a sump at a lower end thereof, and an inclined platform for receiving a diffraction grating thereon within the processing vessel so that a top surface of the diffraction grating is also in an inclined position, whereby fluid runoff from the top surface of the diffraction grating drains into the sump; a recirculation line for channeling fluid from the sump to a recirculation spout positioned to direct fluid onto the top surface of the diffraction grating; a pump for pumping fluid from the sump through the recirculation line and onto the top surface of the diffraction grating, whereby runoff from the top surface of the diffraction grating is recirculated back thereto; means for introducing a cleaning fluid into the processing vessel; means for introducing a rinsing fluid into the processing vessel; valve means for gating the drainage of cleaning fluid waste out from the sump and the recirculation line and into a waste storage container; means for measuring the amount of cleaning fluid waste collected in the waste storage container; a collection vessel fluidically connected to receive fluid from the sump and the recirculation line; valve means for gating fluid drainage out from the sump and the recirculation line and into the collection vessel; means for providing a cleaning-fluid-neutralizing agent into the collection tank in an amount determined by the measured amount of the cleaning fluid waste collected in the waste storage container; a fluid transmission line fluidically connecting the collection tank to the processing vessel; and a pump for pumping fluid from the collection tank through the fluid transmission line and into the processing vessel, for neutralizing all remaining cleaning fluid not collected in the waste storage container.

Another aspect of the present invention includes a method of cleaning a diffraction grating, comprising: positioning the diffraction grating inside a processing vessel so that a top surface of the diffraction grating is in an inclined position; measuring the amount of acid cleaning solution to be used; filling a sump inside the processing vessel with the acid cleaning solution, wherein said sump is positioned to collect runoff from the top surface of the diffraction grating; performing an acid cleaning cycle by pumping the acid cleaning solution from the drainage basin onto the top surface of the diffraction grating via a recirculation line which fluidically connects the sump to a recirculation spout inside the processing vessel which is positioned to direct fluid towards the top surface of the diffraction grating, so that the acid solution is continuously recirculated onto the top surface of the diffraction grating; upon completion of the acid cleaning cycle, purging the acid cleaning solution out from the sump and the recirculation line; measuring the amount of the purged acid solution; filling a collection tank with water, said collection tank fluidically connected to the sump and the recirculation line with a drain valve controlling drainage therefrom into the collection tank; adding an acid-neutralizing solution to the collection tank based on the measured amount of the purged acid cleaning solution; with the drain valve closed, performing a deionized water rinse cycle by providing deionized water from a deionized water source onto the top surface of the diffraction grating via a deionized water spout which is directed towards the top surface of the diffraction grating, while pumping the deionized water runoff collected at the drainage basin through the recirculation line onto the top surface of the diffraction grating, until the processing vessel is filled to overflow; upon completion of the deionized water rinse cycle, draining the contents of the process vessel into the collection tank; with the drain valve closed, filling the drainage basin with a 2^{nd} cleaning fluid; performing a 2^{nd} cleaning cycle by pumping the 2^{nd} cleaning fluid from the sump onto the top surface of the diffraction grating via the recirculation line, so that the 2^{nd} cleaning fluid is continuously recirculated onto the top surface of the diffraction grating; upon completion of the 2^{nd} cleaning cycle, draining the contents of the sump into the collection tank; with the drain valve closed, performing a second deionized water rinse cycle by providing deionized water from the deionized water source onto the top surface of the diffraction grating via the deionized water spout to fill the process vessel until overflow; upon overflow, draining the contents of the sump into the collection tank; with the drain valve open, performing a deionized water rinse cycle by providing deionized water from the deionized water source onto the top surface of the diffraction grating via the deionized water spout.

### V. DETAILED DESCRIPTION

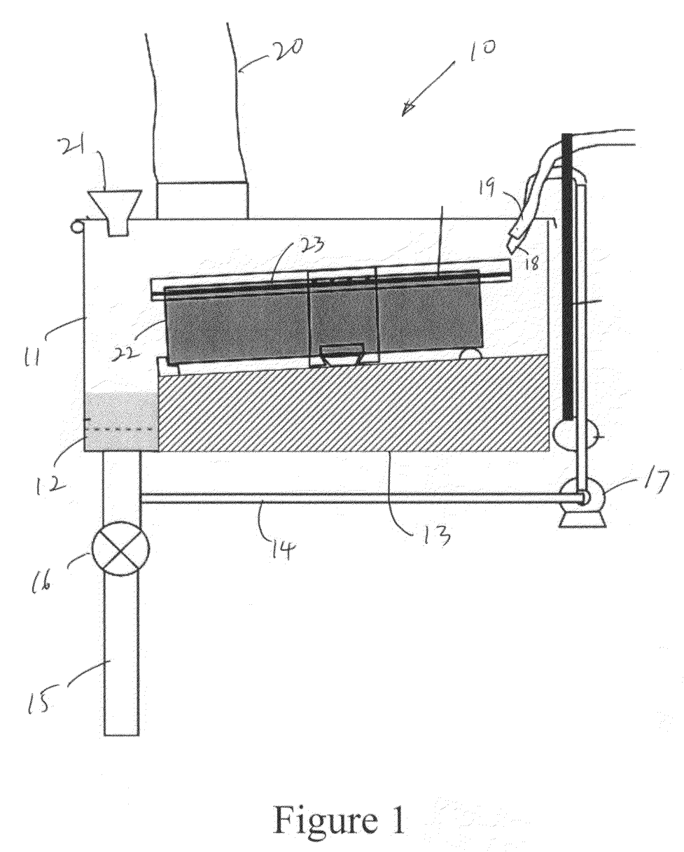

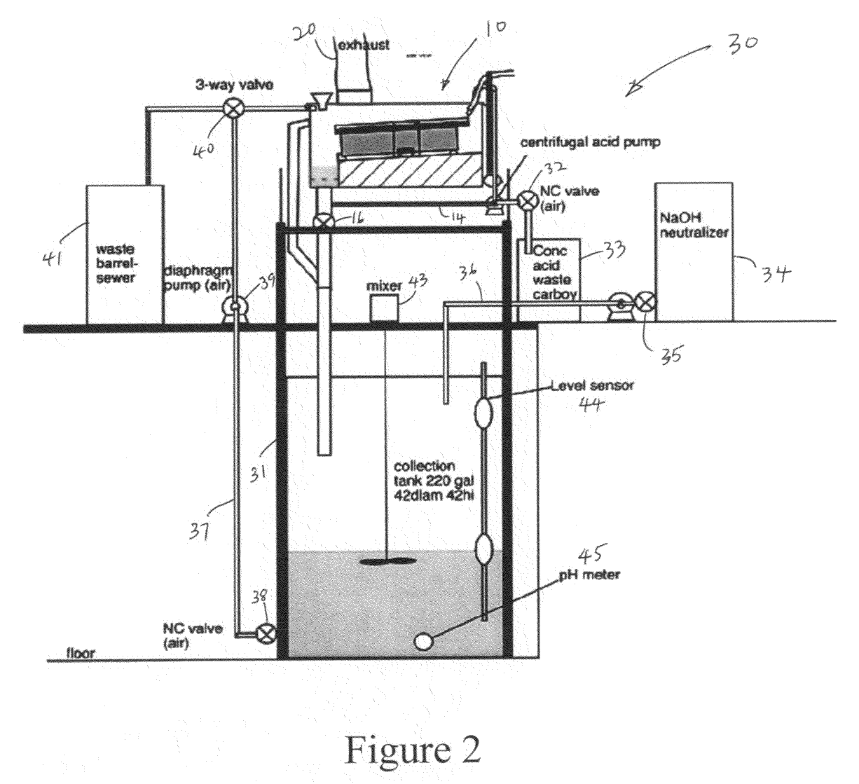

FIGS. 1 and 2 show an exemplary embodiment of the apparatus, generally indicated at 10 (FIG. 1) and system, generally indicated at 30 (FIG. 2) of the present invention. The design of the present invention is motivated by safety, minimization of acid usage, flow/agitation of acid over part to aid in contaminant dissolution, and must be adaptable for several sizes of rectangular substrates. Nanostrip2X, which is a known very aggressive oxidizer/concentrated sulfuric acid solution that is effective at room temperature, has been found to be an effective cleaning agent, and is preferably used as the cleaning fluid. The MSDS for this material is readily available and known in the industry.

As shown in FIG. 1, the apparatus 10 includes a processing vessel 11, which surrounds an enclosed volume. At a lower end of the vessel is a sump 12, i.e. a drainage basis where fluid drains to and collects. An inclined platform 13 is shown which is a preferred manner of receiving a diffraction grating, e.g. 22 in the vessel such that the top surface 23 of the grating is inclined. It is appreciated, however, that other methods of receiving a diffraction grating in the vessel so as to incline the top surface of the grating, is possible as alternatives, e.g. grating mounting structures.

Exemplary materials of construction include high-density polyethylene and Teflon with Hastelloy where necessary although metal parts are preferably kept to a minimum. Corrosive-resistant materials, include but are not limited to, high-density polyethylene, polyvinyl fluoride, Hastelloy, and/or Teflon. The wetted interior of the processing vessel 11 is suitable large so as to receive a diffraction grating, e.g. approximately 100×60×30 cm in dimension. In this regard, an inclined platform nominally 100×50×10 cm will support the optic. While any incline of 1-90 degrees is possible, preferably the incline is about 2-3° draining to the sump 12 (shown as a lower channel) at the bottom of the vessel. For the above mentioned dimensions, the sump may be approximately 10 L capacity, and is used as the reservoir for processing liquid to be recirculated during the cleaning step. With these preferred dimensions, large optics, such as 95×45×10 cm, may be treated with this solution. However, it is only one face, i.e. top surface of this optic that requires this cleaning step. The vessel 10 also includes a fill inlet 21 where cleaning agents, such as Nanostrip 2X may be supplied into the vessel, as well as an exhaust line 20 for evacuating any potentially toxic vapors that may be present inside the vessel.

As shown best in FIG. 1, the sump 12 is fluidically connected to a recirculation line 14 which is connects to a recirculation spout 18 near the top of the processing vessel 10. In particular the recirculation spout is positioned to direct fluid flow to the top surface 23 of the diffraction grating, preferably starting from the elevated end so that runoff may traverse the entire span of the top surface. A pump 17, such as a centrifugal acid pump, may be employed here. It is appreciated that more than one recirculation spout may be employed. And the recirculation spout may be any means known in the art to introduce fluids to irrigate and wet an area, such as for example, a scannable recirculation spout (e.g. actuation of the spout to stream fluid across the top surface) or a spray nozzle. It is appreciated that more than one deionized water spout may be employed. Also shown in FIG. 1 is a rinse fluid inlet spout 19, which is connectable to a rinse fluid source (not shown). Preferably the rinse fluid is deionized water (DI). As shown in FIG. 1, the deionized water spout 19 is also preferably directed towards an elevated end of the top surface of the diffraction grating so that runoff may traverse the entire span of the top surface. More than one spout may be employed here as well, and may be scannable spouts or spray nozzles. Also, an in-line heater (not shown) known in the art may be connected upstream of the deionized water spout 19 to heat the deionized water prior to being directed onto the top surface of the diffraction grating, to further enhance rinsing effectiveness. Also shown in FIG. 1 is a drain valve 16 which controls/gates flow out from the sump 12 and recirculation line 13, and into fluid line 15.

Preferably the fluid line 15 connects to a collection tank 31, shown schematically in FIG. 2 as part of a larger cleaning system. Generally, the system includes the apparatus 10 discussed above (i.e. processing vessel, sump, recirculation line for acid processing), as well as a separate drain which connects to an acid waste carboy 33 (shown controlled via valve 32), an exhaust line for maintaining negative pressure and face velocity at openings, a collection tank for rinse and neutralization, a metered neutralizing agent dispenser (e.g. 50% NaOH dispenser) for conditioning/neutralization of the remaining cleaning solution in the processing vessel. Additionally, interlocks and sensors are preferably employed, and manage by a controller, such as a programmable logic controller (PLC) control system.

It is appreciated that the waste storage container is preferably a separate standalone unit. In the alternative, however, the waste storage container may be an integral component of the system of the present invention, i.e. as a temporary waste holding tank. In any case, cleaning solution waste drained from the sump 12 and recirculation line 14 via valve 32, is preferably measured, such as by measuring the difference in weight of the acid waste carboy after waste collection. This determination is used later for dispensing the neutralizing agent.

FIG. 3 also shows the collection tank 31 below the processing vessel 11 such that fluid drained via valve 15 enters the collection tank. A mixer is shown provided for mixing fluids therein. A neutralizing agent dispenser 34 is also connected to the collection tank 31 for dispensing the neutralizing agent. The neutralizing agent is preferably NaOH. The amount to dispense is determined based on the measured amount of cleaning fluid at the acid waste carboy. Additionally, a pH meter 45 is also in the collection tank to monitor and determine the need for additional dispensing control.

As shown in FIG. 3, a fluid transmission line 31 and a pump 38 is also provided to recirculate fluid in the collection tank 31 back to the processing vessel 11. A diaphragm pump 39 is provided as well as a valve 38 to control flow back to the processing vessel. A three way valve 40 is also shown which controls whether fluid from the collection tank is directed back to the processing vessel, or redirected to a waste barrel 41 or purge to the sewer. By redirecting and recirculating the fluid from the collection tank 31 back to the processing vessel, any cleaning solution remaining in the vessel and the diffraction grating may be effectively neutralized.

The described apparatus and system is preferably automated, such as by using a controller (e.g. programmable logic controller PLC) for controlling the fluid fill, circulation, and drainage functions in the various stages of operation of the present invention, so as to perform multi-step cleaning of the top surface of the diffraction grating. A level sensor 44 is also shown provided to determine when the collection tank needs to be purged.

An exemplary process illustrating the method of cleaning a diffraction grating using the apparatus and system of the present invention is described as follows:

Optic to be cleaned will be transferred from its PETG container into the processing station using the overhead crane and an approved lifting fixture.

5 gal. acid waste carboy placed into position

Acid to be added to process weighed and weight recorded.

Collection tank charged with approx. 50 gal of city water.

Lid closed and startup sequence initiated through PLC

Acid solution will be introduced into process through manual pour into funnel designed for this purpose

Recirculation initiated. Acid will be pumped from reservoir onto surface of optic, continuously recirculating, for approximately 1 hr.

Acid waste valve opened; acid pumped into waste carboy.

Acid waste valve closed. Weight of collected acid recorded automatically using scale.

Mixer started in collection vessel. Weight of NaOH needed to neutralize known amount of acid is metered into collection vessel.

DI water rinse initiated with recirc pump running and drain valve closed. Process tank filled to overflow.

Drain valve opened, process tank contents drained to collection tank.

Drain valve closed. TMAH-based (pH˜12) developer solution added to reservoir (1-2 gal).

Recirc pump started to rinse part surface with TMAH solution, approx 5 min.

Drain valved opened, DI rinse begun, approx 2 min.

Drain valve closed. Solution pumped up from collection tank to fill process vessel to overflow.

Drain valve opened, pumping from collection tank stopped, and final DI rinse begun. Approx 5 min.

With regard to acid/base balance, it is estimated that that between 100-200 ml of concentrated acid residue will remain adhering to process vessel walls, optic surfaces and in liquid lines following pumping of the acid waste to the waste carboy. This amount will be precisely known by measuring (such as by weighing) the amount introduced and amount collected in waste container. The amount of base needed to neutralize this known amount will be metered into ˜50 gallons of water in the collection tank during the rinse process. The resulting solution at the end of the rinse process will be within the pH limits for disposal to sewer. This will be monitored by pH meters and sampling.

The neutralization of 250 ml of concentrated H2SO4 by NaOH in 50 gal of water releases heat sufficient to raise the temperature of this amount of water by less than 1 degree C. (based on a reaction enthalpy H+OH→H2O(aq) of −79.9 kJ/mol).

It is important from a safety standpoint to neutralize the rinsewater as part of the process. This is in part due to compatibility with other processes in the facility. A sol-gel dip tank for AR coating, containing ˜100 gallons of ethanol solution, shares the same secondary containment pit as this proposed equipment. Concentrated sulfuric acid and ethanol do not mix, and so neutralizing the acidic rinse stream immediately as it enters the collection tank will assure that no mixing of these chemicals is possible in the event of an emergency situation.

Additional devices, such as sensors and interlocks may be employed for operating the apparatus and system, such as in a preferably automated manner. For example a proximity switch may be used to sense lid closure, and enable acid recirculation and DI water rinse. An airflow switch may be used for exhaust airflow, and enable acid recirculation, and DI water rinse. A float switch may be used to detect collector tank level and enable DI water rinse. A pH meter may be used to measure collecter tank pH, and enable NaOH charging into the collection tank and enable drain pumping.

Acid handling by operators will preferably include manually filling the reservoir with 1 to 2 gallons of Nanostrip2X, poured from HDPE 1-gal containers they were received in, into the top of the strip station through the funnel in the top of the container placed for this purpose. The operator will also remove and place a lid on the 5 gal carboy containing the acid waste from the process. While handling acid, the operator will wear the following: Full face shield, Butyl rubber or neoprene gloves, Lab cleanroom suit, Tyvek (HDPE) apron.

While particular operational sequences, materials, temperatures, parameters, and particular embodiments have been described and or illustrated, such are not intended to be limiting. Modifications and changes may become apparent to those skilled in the art, and it is intended that the invention be limited only by the scope of the appended claims.

We claim:

1. An apparatus for cleaning diffraction gratings comprising:
a processing vessel having a sump at a lower end thereof, and means for receiving a diffraction grating within the processing vessel so that a top surface of the diffraction grating is in an inclined position, whereby fluid runoff from the top surface of the diffraction grating drains into the sump;
a recirculation line for channeling fluid from the sump to a recirculation spout positioned to direct fluid onto the top surface of the diffraction grating;
a pump for pumping fluid from the sump through the recirculation line and onto the top surface of the diffraction grating, whereby runoff from the top surface of the diffraction grating is recirculated back thereto;
means for introducing a cleaning fluid into the processing vessel;
means for introducing a rinsing fluid into the processing vessel; and
means for draining fluid out from the sump and the recirculation line.

2. The apparatus of claim 1,
wherein said means for receiving a diffraction grating within the processing vessel is an inclined platform draining into the sump.

3. The apparatus of claim 1,
wherein the recirculation spout is scannable across the top surface of the diffraction grating.

4. The apparatus of claim 1,
wherein the recirculation spout is a spray nozzle.

5. The apparatus of claim 1,
wherein said means for introducing a cleaning fluid into the processing vessel comprises a fill inlet.

6. The apparatus of claim 1,
wherein said means for introducing a rinsing fluid into the processing vessel comprises a deionized water spout fluidicially connectable to a deionized water source and positioned to direct deionized water onto the top surface of the diffraction grating.

7. The apparatus of claim 6,
wherein the deionized water spout is scannable across the top surface of the diffraction grating.

8. The apparatus of claim 6,
wherein the deionized water spout(s) is a spray nozzle.

9. The apparatus of claim 6,
further comprising the deionized water source fluidically connected to the deionized water spout.

10. The apparatus of claim 6,
wherein said means for introducing a rinsing fluid further comprises an in-line heater connected upstream of the deionized water spout to heat the deionized water.

11. The apparatus of claim 1,
further comprising an exhaust line connectable to an evacuation source for exhausting vapors from the processing vessel.

12. The apparatus of claim 11,
further comprising the evacuation source connected to the exhaust line.

13. The apparatus of claim 1,
wherein said means for draining fluid out from the sump and the recirculation line includes valve means for gating the drainage of cleaning fluid waste from the sump and the recirculation line into a waste storage container.

14. The apparatus of claim 13,
further comprising: means for measuring the amount of cleaning fluid waste collected in the waste storage container; a collection tank fluidically connected to receive fluid from the sump and the recirculation line; means for providing water into the collection tank; and means for providing a cleaning-fluid-neutralizing agent into the collection tank in an amount determined by the measured amount of cleaning fluid waste collected in the waste storage container; a fluid transmission line fluidically connecting the collection tank to the processing vessel; and a pump for pumping fluid from the collection tank through the fluid transmission line and into the processing vessel, for neutralizing all remaining cleaning fluid not collected in the waste storage container,
wherein said means for draining fluid out from the sump and the recirculation line includes valve means for gating fluid drainage from the sump and the recirculation line into the collection tank.

15. An apparatus for cleaning a diffraction grating comprising:
a processing vessel having a sump at a lower end thereof, and an inclined platform for receiving a diffraction grating thereon within the processing vessel so that a top surface of the diffraction grating is also in an inclined position, whereby fluid runoff from the top surface of the diffraction grating drains into the sump;
a recirculation line for channeling fluid from the sump to a recirculation spout positioned to direct fluid onto the top surface of the diffraction grating;
a pump for pumping fluid from the sump through the recirculation line and onto the top surface of the diffraction grating, whereby runoff from the top surface of the diffraction grating is recirculated back thereto;
means for introducing a cleaning fluid into the processing vessel;
means for introducing a rinsing fluid into the processing vessel;
valve means for gating the drainage of cleaning fluid waste out from the sump and the recirculation line and into a waste storage container;
means for measuring the amount of cleaning fluid waste collected in the waste storage container;
a collection vessel fluidically connected to receive fluid from the sump and the recirculation line;
valve means for gating fluid drainage out from the sump and the recirculation line and into the collection vessel;
means for providing a cleaning-fluid-neutralizing agent into the collection tank in an amount determined by the measured amount of the cleaning fluid waste collected in the waste storage container;
a fluid transmission line fluidically connecting the collection tank to the processing vessel; and
a pump for pumping fluid from the collection tank through the fluid transmission line and into the processing vessel, for neutralizing all remaining cleaning fluid not collected in the waste storage container.

16. A method of cleaning a diffraction grating, comprising:
positioning the diffraction grating inside a processing vessel so that a top surface of the diffraction grating is in an inclined position;
measuring the amount of acid cleaning solution to be used;
filling a sump inside the processing vessel with the acid cleaning solution, wherein said sump is positioned to collect runoff from the top surface of the diffraction grating;
performing an acid cleaning cycle by pumping the acid cleaning solution from the drainage basin onto the top surface of the diffraction grating via a recirculation line which fluidically connects the sump to a recirculation spout inside the processing vessel which is positioned to direct fluid towards the top surface of the diffraction grating, so that the acid solution is continuously recirculated onto the top surface of the diffraction grating;
upon completion of the acid cleaning cycle, purging the acid cleaning solution out from the sump and the recirculation line;
measuring the amount of the purged acid solution;
filling a collection tank with water, said collection tank fluidically connected to the sump and the recirculation line with a drain valve controlling drainage therefrom into the collection tank;
adding an acid-neutralizing solution to the collection tank based on the measured amount of the purged acid cleaning solution;
with the drain valve closed, performing a deionized water rinse cycle by providing deionized water from a deionized water source onto the top surface of the diffraction grating via a deionized water spout which is directed towards the top surface of the diffraction grating, while pumping the deionized water runoff collected at the drainage basin through the recirculation line onto the top surface of the diffraction grating, until the processing vessel is filled to overflow;
upon completion of the deionized water rinse cycle, draining the contents of the process vessel into the collection tank;
with the drain valve closed, filling the drainage basin with a 2^{nd} cleaning fluid;
performing a 2^{nd} cleaning cycle by pumping the 2^{nd} cleaning fluid from the sump onto the top surface of the diffraction grating via the recirculation line, so that the 2^{nd} cleaning fluid is continuously recirculated onto the top surface of the diffraction grating;
upon completion of the 2^{nd} cleaning cycle, draining the contents of the sump into the collection tank;
with the drain valve closed, performing a second deionized water rinse cycle by providing deionized water from the deionized water source onto the top surface of the diffraction grating via the deionized water spout to fill the process vessel until overflow;
upon overflow, draining the contents of the sump into the collection tank;
with the drain valve open, performing a deionized water rinse cycle by providing deionized water from the deionized water source onto the top surface of the diffraction grating via the deionized water spout.

17. The method of claim 16,
wherein in the acid cleaning cycle the acid solution is recirculated for about 1 hour.

18. The method of claim 16,
wherein the acid solution is purged out from the drainage basin and the recirculation line by opening an acid waste valve of the recirculation line, pumping acid into an acid waste carboy, and closing the acid waste valve.

19. The method of claim 16,
wherein the step of filling the collection tank with water comprises filling the collection tank with about 50 gal of water.

20. The method of claim 16,
wherein the acid-neutralizing solution is added in an amount determined based on the weight of the purged acid solution.

21. The method of claim 16,
wherein the acid-neutralizing solution is NaOH.

22. The method of claim 16,
further comprising mixing the acid-neutralizing solution together with the water in the collection vessel.

23. The method of claim 16,
wherein in the 2^{nd} cleaning cycle the 2^{nd} cleaning fluid is recirculated for about 5 minutes.

24. The method of claim 16,
wherein the second deionized water rinse cycle is performed for about 10 minutes.

25. The method of claim 16,
wherein the final deionized water rinse cycle is performed for about 5 minutes.
